(19) United States
(12) Patent Application Publication
(10) Pub. No.: US 2026/0238682 A1
(43) Pub. Date: Aug. 13, 2026

(54) NETWORK POLICY OF A CLIENT DEVICE BASED ON MACHINE OR HUMAN CONTROL

(71) Applicant: Cisco Technology, Inc., San Jose, CA (US)

(72) Inventors: Robert Edgar Barton, Richmond (CA); Bhavik Shah, Bangalore (IN); Barry Qi Yuan, Vancouver (CA)

(21) Appl. No.: 19/052,760

(22) Filed: Feb. 13, 2025

(51) Int. Cl. H04L 9/40

(52) U.S. Cl. CPC H04L 63/20

(57) ABSTRACT

Disclosed are systems, apparatuses, methods, and computer-readable media for setting a network policy at a client device. A method includes: generating, by an agent of the client device, a profile for each process being executed; in response to receiving a first kernel event associated with a network connection to a destination address, identifying a first process associated with the first kernel event and a first profile corresponding to the first process; determining a source initiating the first kernel event based on the first profile of the first process and the first kernel event, wherein the source initiating the first kernel event comprises one of a user, the first process, and a second process that executes the first process; obtaining a network policy associated with the network flow; and communicating with the destination address using the network connection based on the network policy applied to the network flow

### TECHNICAL FIELD

The disclosure relates generally to communication networks and, more specifically but not exclusively, to network policy of a client device based on machine or human control.

### DESCRIPTION OF THE RELATED TECHNOLOGY

A remote connection agent, such as Cisco Secure Client, facilitates secure and seamless access to a company's private network infrastructure over the Internet. Similar remote connections agents use Identity Provider (IdP) integration to provide seamless authentication and access to enterprise networks, cloud services, and applications. This integration leverages protocols like security authentication markup language (SAML), OAuth 2.0, or OpenID Connect (OIDC) to enable secure and centralized identity management. The agents create a virtual private network (VPN) encrypted tunnel between the user's device and the corporate network and ensure that data transmitted between the user and the network remains confidential and protected from unauthorized access, even when using public or untrusted networks.

The agent typically functions through a combination of client-side software and server-side infrastructure. The agent, installed on the user's device, authenticates the user through credentials such as usernames, passwords, or multi-factor authentication (MFA). Once authenticated, the agent negotiates encryption protocols and establishes the VPN connection with a VPN gateway server hosted by the company. This gateway acts as a bridge between the remote user and the internal company network, allowing the user to access internal resources such as file servers, applications, and intranet sites as though they were physically on-site.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a conceptual illustration of accessing a private network using an agent in accordance with some aspects of the disclosure;

FIG. 2 is a conceptual illustration of a bytecode-based packet filter that can instrument an operating system or an application in accordance with some aspects of the disclosure;

FIG. 3 is a conceptual diagram of a network stack layers for network communications using an agent to apply policies in accordance with some aspects of the disclosure;

FIG. 4 is a sequence diagram illustrating an agent applying policies and performing a context switch in accordance with some aspects of the disclosure;

FIG. 5 is a conceptual diagram illustrating an agent configuring a sandbox for a process in accordance with some aspects of the disclosure;

FIG. 6 is a flow diagram of an example process for linking network policy of a client device based on machine or human control in accordance with some aspects of the disclosure;

FIG. 7 illustrates a block diagram of memory space of an operating system in accordance with some examples of the disclosure; and

FIG. 8 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Overview

Disclosed are systems, apparatuses, methods, computer readable medium, and circuits for setting a network policy at a client device. According to at least one example, a method includes: building, by an agent of the client device, profiles associated with each process of the client device; in response to receiving a network connection request initiated by a process, classifying a source of the network connection request based on a profile corresponding to the process; obtaining a network policy associated with a network connection for the network connection request based on the source of the network connection request and the process; communicating with a destination identified in the network connection request based on the network policy. For example, the client device is configured to build profiles associated with each process of the client device; in response to receiving a network connection request initiated by a process, classify a source of the network connection request based on a profile corresponding to the process; obtain a network policy associated with a network connection for the network connection request based on the source of the network connection request and the process; and communicate with a destination identified in the network connection request based on the network policy. In some aspects, the source of the network connection request comprises at least one of a local user, a remote user, and process of the client device.

In some aspects, the agent can be part of a network authentication agent, such as a remote connection agent for securely connecting to private network infrastructure through a public network, or through a virtual private network (VPN).

In some aspects, different policies can be enacted based on whether the request is initiated through a remote interface (e.g., a remote connection) or a local interface (e.g., a physical interface such as a keyboard). For example, the client device may, based on the user accessing the network connection request, determine a context associated with a process being used through the remote interface; and intercept at least one of file system events and shell events corresponding to the context. In one example, the intercepting of the shell events comprises initiating a shell with limited access to a file system, memory, and network systems. In another example, the intercepting of at least one of the file system events comprises providing hooks the privileged agent to intercept the requests in files associated with the context and redirect the file system event to an empty file.

The client device can use a complex profile to identify the source of the network request. For example, the client device may check events proximate to a time of the network connection request; identify user input events proximate to the time of the network connection request; and based on identifying a user input or a process corresponding to an event that triggers the network connection request, determine the source of the network connection request. The client device may also detect a reclassification event associated with a process, wherein the reclassification event indicates a change of the source of the source of the network connection request; and determine a reclassification of the process.

### Example Embodiments

There is no simple mechanism to distinguish between human-initiated and computer-initiated network data. Human-initiated data, such as browsing a website or sending an email, reflects deliberate actions and is often predictable in behavior and scale. In contrast, computer-initiated data, such as background updates, automated API calls, or malicious bot activities, can occur without user awareness, potentially leading to unexpected network congestion or security vulnerabilities.

Computer-initiated network data requests encompass a wide range of activities, both beneficial and potentially harmful. For example, automated software updates ensure applications and operating systems remain secure and functional, while background syncing of cloud storage services keeps files synchronized across devices. Additionally, sensors such as thermostats and security cameras periodically send data to their servers for monitoring and control. Malicious activities, such as botnet traffic executing Distributed Denial-of-Service (DDoS) attacks, can flood networks and disrupt services. Similarly, spyware and data exfiltration programs covertly send sensitive user data to unauthorized servers, compromising security and privacy.

Identifying the different types of network requests allows for prioritizing legitimate traffic, balancing requests to ensure workloads are efficiently allocated, and seamlessly allowing implementation of security measures. This is particularly important in automated environments where unchecked computer-initiated activities could overwhelm resources or expose systems to attacks like DDoS or data exfiltration.

In some aspects, systems, and techniques for setting a network policy at a client device are disclosed. In one illustrative aspect, an enhanced Berkely Packet Filter (eBPF), which is available across different operating systems (OSs), may be enabled at a client device to identify traffic that originates at that client and classify the origination of that traffic. In one aspect, an agent can include instructions to build profiles associated with each process of the client device and, in response to receiving a network connection request initiated by a process, classify a source of the network connection request based on a profile corresponding to the process. Notably, processes can quickly switch from human to computer control and the agent is configured to classify the network requests based on the profile as being human-initiated or machine-initiated using the profiles. The profiles can cross-reference different information (e.g., inputs), and network request information (e.g., destination address) to build a rich understanding of the classification. Based on the classification, the agent may set policies pertaining to the type of traffic. For example, the agent may limit the bandwidth of certain transactions, such as file synchronization services, but increase the bandwidth of others, such as sending an email with a large attachment.

Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

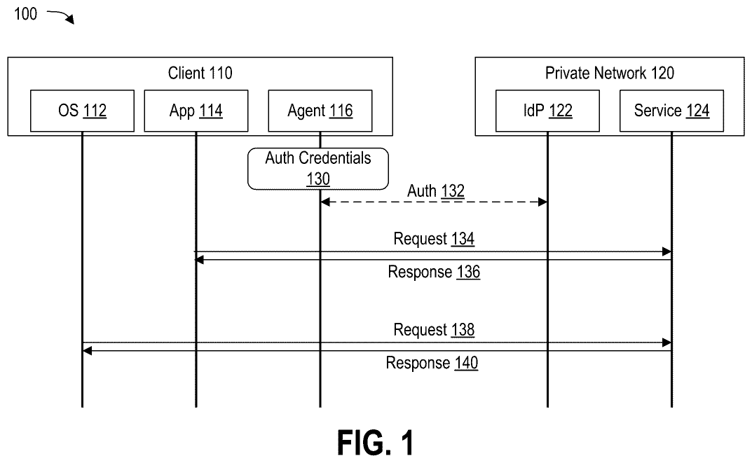

FIG. 1 is a conceptual illustration of a system 100 and accessing a private network using an agent in accordance with some aspects of the disclosure. A client device 110 may be configured to access a private network 120. The client device 110 may include an operating system (OS) such as operating system 112 executing at least one application such as application 114, and includes an agent 116 to exchange authentication credentials with the private network 120. The private network 120 may include an identity provider 122 and at least one service such as service 124 (e.g., a cloud service). In some aspects, aspects of the private network 120 are excluded for clarity.

To access the private network 120, a user may input authentication credentials 130 via the agent 116, which exchanges authentication credentials 132 and other information, such as various certificates to provide an identity of the agent 116. The identity provider 122 receives the authentication credentials and may authenticate the client device 110 for access. Although a single factor is illustrated, the identity provider 122 may have multiple authentication factors such as sending private codes, requiring execution of external authentication functions, and so forth. The identity provider 122 responds to the agent 116 indicating success as part of the authentication credentials 132.

At the end of the authentication flow initiated by the agent 116, the client device 110 is configured to have access to the private network 120. For example, the application 114 may send a request 134 to the service 124, which provides a response 136 for the application 114 to consume. In some aspects, the operating system 112 itself (or an integrated application, a library, etc.) may send a request 138 to the service 124, which returns a response 140.

In this case, the identity provider 122 (and corresponding infrastructure such as a firewall) are unable to distinguish between requests that are initiated by the applications under the control of users or by applications under the control of the system or some other aspect (e.g., a software updater). In some cases, being able to distinguish between the different types of traffic, such as in a private network 120, can have significant benefits. For example, the private network 120 can block data requests from machine-based instructions to scrape or retrieve a volume of information, thereby implementing a data loss prevention (DLP) to prevent leakage of confidential internal assets.

In some aspects, an agent 116 may be extended to differentiate whether network traffic is initiated by a user or the system (e.g., an internal process) by including a privileged agent. For example, the agent 116 may include a bytecode-based packet filter (not shown) that may obtain privileged access to the system, such as by using eBPF. The packet filter may insert system calls or kernel hooks related to networking, such as connect( ), sendto( ), or write( ) at the kernel level and map information to the user space. For example, the packet filter may use the hooks to trace the source process initiating the traffic and then capture process identifiers, user identifiers, and command-line arguments. By correlating this data with process lineage, the privileged agent may determine if the network connection requests stems from user-initiated actions (e.g., a browser or manual script) or system-level processes (e.g., daemons or background updates). The packet filter is lightweight and does not require modifying application code and may allow enhanced visibility into network activity, improved security by detecting anomalies such as malware-generated traffic, and the ability to fine-tune network policies for user-specific or system-level traffic.

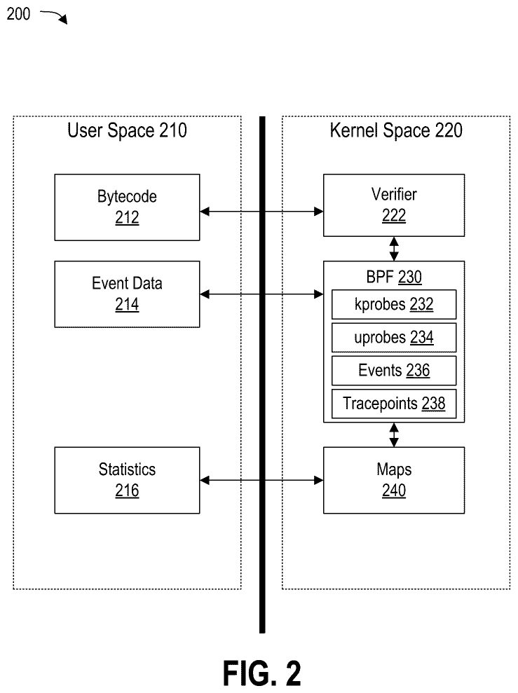

FIG. 2 is a conceptual illustration of a system 200 that implements bytecode-based packet filter to instrument an operating system or an application with additional functionality in accordance with some aspects of the disclosure. Instrumentation bytecode is computer object code that is interpreted into binary machine code to modify various aspects of software systems, such as to measure performance of various aspects of the system or supplement various functions. The system 200 is logically divided into a user space 210 where a user executes various operations, stores application information, and so forth, and a kernel space 220 where system events occur and is restricted for security to prevent malicious actors. In some aspects, bytecode 212 can be loaded into the user space 210, which is then provided to a verifier 222 within the kernel space 220 that analyzes the bytecode 212 for security functions and ensures that the instructions are constrained based on a plurality of rules. For example, in an eBPF filter, the bytecode 212 is analyzed for looping instructions and reverse branches and permits the bytecode 212 to operate based on not including looping instructions and reverse branches. Looping instructions and reverse branches can be used to comprise the security of the system 200 and therefore may be strictly prohibited. The verifier implements a plurality of rules to prevent malicious instructions that could compromise the security of the system 200 (e.g., by gaining root or administrator access).

In the event the verifier 222 validates the bytecode 212, the bytecode 212 is then provided to the eBPF 230 for system modification and instrumentation. In some aspects, the eBPF 230 can configure various triggers to enable supplemental functionality. In one example, the eBPF 230 may analyze a wireless 802.11 packet to determine if the 802.11 packet is a beacon (e.g., an 802.11K beacon), or if a network packet is flood traffic associated with a distributed denial of service (DDOS) attack.

In some aspects, the eBPF 230 executes the bytecode 212 and performs various actions such as measuring latency, summarizing latency as a histogram, analyzing stack traces, network logging functions, sending in-band network data (e.g., on the same network interface that triggers the bytecode 212), sending out-of-band network data (e. g, on a different network interface that triggers the bytecode 212), etc. In one illustrative example, the eBPF 230 may include a just in time (JIT) compiler that converts the bytecode into machine instructions. In some aspects, the bytecode 212 can be attached to different sources such as kprobes 232, uprobes 234, tracepoints 236, and events 238.

The kprobes 232 enable kernel dynamic tracing, the uprobes 234 enable user level dynamic tracing, the tracepoints 236 enable kernel static tracing, and the events 238 enable time sampling and performance metrics. For example, the kprobes 232 can be triggered by network events to enable intrusion detection functions, and the events 238 can be configured to measure latency and system responsiveness, particularly under load.

In some aspects, the eBPF 230 can pass data back to user space as events 214 or maps 240. In some aspects, the maps can generate various statistics 216 within the user space 210 (e.g., network performance, latency, etc.). In some aspects, the maps 240 maps can implement arrays, associative arrays, and histograms, and are suited for passing summary statistics. In other cases, the eBPF 230 can provide instrumentation to provide information to external systems for supplemental reporting, add additional information to a report, etc.

Although an eBPF 230 is described, the functionality described herein can also be added to non-Linux based systems with network protocol extensions. For example, a real-time OS may receive a network protocol extension to supplement and standardize network reporting, which can improve intrusion detection and other security functions. Other OS variants are implementing eBPF functionality.

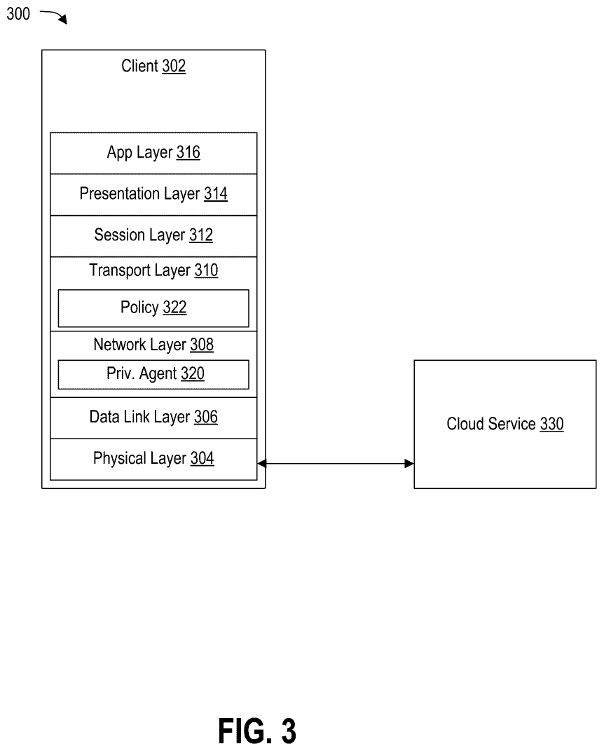

FIG. 3 is a conceptual diagram 300 of a network stack implemented on a client device using an agent to apply policies in accordance with some aspects of the disclosure. In some aspects, a client device 302 includes various abstractions that are used to separate concerns and provide an agnostic standard how network communication occurs between different systems. The network stack simplifies troubleshooting, improves interoperability between diverse devices and protocols, and allows modular development of networking technologies.

The network stack includes a physical layer 304, a data link layer 306, a network layer 308, a transport layer 310, a session layer 312, a presentation layer 314, and an application layer 316. Each of the layers is separated into discrete functions and provides functionality to enable a variety of communication services, from wireless local networking to cellular communications.

For example, the physical layer 304 represents the transmission and reception of data across the physical medium such as a conductive medium (e.g., a physical network) or a lossy medium (e.g., a wireless channel). The physical layer transmits data and receives data in symbols and includes, for example, a modem to translate bits into symbols to transmit data into electricity, light, or radio signals and controls the rates at which the symbols are sent over the chosen medium.

The data link layer 306 is configured to receive network data and encapsulate the network data into into frames for transmission at the physical layer 304. The data link layer 306 manages connections between two different nodes, including setting up the connection, identifying and correcting any bit errors that occur at the physical layer, and terminating the connection once the session is complete.

The network layer 308 receives data from other layers and configures packets and is also responsible for routing network packets to destination IP addresses. In some aspects, an agent 320 is configured to execute at the network layer 308 and may be implemented by implementing hooks into drivers and other software modules that implement the network layer 308.

The transport layer 310, the session layer 312, the presentation layer 314, and the application layer 316 may be referred to as a host layer, which are the various media layers at the device that separate different functions. The transport layer 310 is configured to generate protocol data units that segment data for transmission or combine protocol data units into a stream of data that can be provided to the components of the client device 302. The transport layer 310 may also include at least one policy such as policy 322 that can be used to control a stream of data provided to the network layer 308. In some aspects, the policy 322 may operate at the transport layer 310 to provide a single point of control based on functions requested by the agent 320.

In some aspects, the session layer 312 manages sessions between nodes and may include more application-specific functions such as session management and authentication functions. For example, the session layer 312 may include setup, authentication, and termination of a network connection.

The presentation layer 314 is configured to translate data from network data into the formats expected by an application. For example, encoding, decoding, and encryption are managed at the presentation layer 314.

The application layer 316 includes protocols designed for end-users and include, for example, hypertext transfer protocol (HTTP) and other application-specific functions.

The network stack illustrates the logical separation and how the different aspects of the network can be handled and shows an example of how an agent 320 can be implemented. In many cases, many of the layers are transparent. For example, socket requests can be directly requested at the transport layer 310. The agent 320 is configured to transparently handle any requests at the transport layer 310 in a consistent manner without requiring any further instrumentation in software. In this case, the agent 320 can access privileged functions to implement network policies transparently.

For example, the physical layer 304 may physically interface with a network (not shown) to connect to a cloud service 330. The agent 320 is configured to implement the policy 322 to control requests to the cloud service 330 and responses received by the cloud service 330. In some aspects, the agent 320 is configured to analyze various information such as process identifiers, executable, user identifiers, arguments, and other information to assess whether.

As further described below, the agent 320 may also be able to access other privileged kernel functions, such as the file system and shell, to provide additional security.

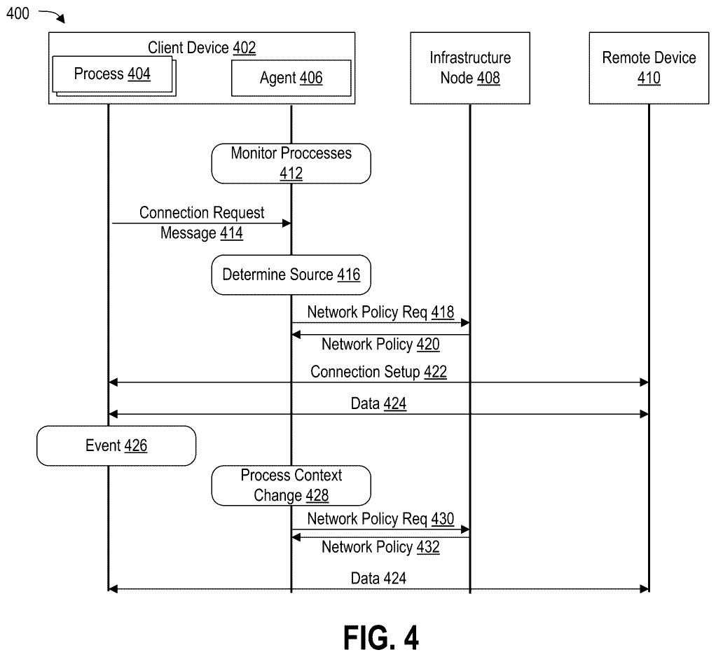

FIG. 4 is a sequence diagram illustrating a system 400 including an agent applying policies and performing a context switch in accordance with some aspects of the disclosure. The system 400 includes a client device 402 that executes at least one process such as process 404 and an agent 406 configured to link network policy of a client device based on machine or human control. The system 400 also includes an infrastructure node 408 that serves policies in connection with connections to at least one remote device such as remote device 410 (e.g., a cloud service, etc.).

In some aspects, the agent 406 is configured to monitor processes associated with the client device 402 at block 412. For example, the agent 406 is privileged bytecode implemented with eBPF and may be configured to receive OS events such as process initiation, process termination, network connection requests, network connection tear down, etc. In this case, the agent 406 is configured to profile each process on the system 400 and record data, such as events triggered by a process, the user identifier (uid) initiating the event, arguments associated with the event, etc. For example, the agent 406 may detect a shell command (e.g., “lsof” to list all open files) issued by a process and corresponding commands (e.g., a path to limit the lsof command). In another example, the agent 406 may detect an IP address associated with a network request, and determine that the network connection is based on a machine instruction or a human input event from a human input device. In some aspects, the agent 406 is configured to determine whether the process and its events are associated with the machine itself (e.g., check software update) or with a human input event (e.g., request connection to a cloud service).

For example, the agent 406 may receive (e.g., based on a hook) a connection request message 414 to connect to the remote device 410. In response, at block 416, the agent 406 is configured to ascertain a source of the connection request message 414. For example, the agent 406 may ascertain whether the source of the connection request message 414 is associated with a machine instruction or a human input event. The agent 406 then sends a network policy request 418 to the infrastructure node 408, and the network policy request 418 may identify a source of the network request (e.g., machine instruction, human input event, etc.).

In response, the infrastructure node 408 is configured to respond with a corresponding network policy 420. The corresponding network policy 420 is configured based on the source of the network request and allows different parameters to be applied at the client device 402 to control the interface with the remote device 410. For example, the process 404 may send a connection setup message 422 to establish a socket or other network connection (e.g., HTTP) including parameters based on the corresponding network policy 420. After forming the connection, the process 404 and the remote device 410 communicate data 424 based on the connection dictated by the corresponding network policy 420. The process 404 may also implement various controls to impede or accelerate the network connection.

In some aspects, an event 426 may occur that can cause the agent to process a context change at block 428. For example, the agent 406 can detect that the process 404 changes control source from machine instruction to human input events (or vice-versa). Based on the context change, the agent 406 can send a network policy 430 to the infrastructure node 408 and receive a revised network policy 432 from the infrastructure node 408. In this case, the agent 406 can transparently update the network policy within the client device 402 without any changes as the process 404 exchanges data 424 with the remote device 410.

In this case, the agent 406 is configured to transparently apply network policies at the client device 402 based on the source of the events or instructions, allowing the agent 406 to tailor network connections and policies based on whether a user is providing human input events through a human input device or whether the instructions are being pushed from the machine or other application the user is executing.

In the example illustrated in FIG. 4 is premised based on a connection request for purposes of illustration and a network connection. In some aspects, the network policy can be applied at different levels of abstraction. For example, a network connection refers to an established communication link between two endpoints, such as a client and a server, over a network. A network connection can include different network flows over the communication links, and the network flow represents the aggregation of related packets sharing common characteristics generally based on the 5 tuple of source IP address, destination IP address, source port, destination port, and protocol. The network connection is tied to the actual stateful exchange of data between endpoints and a network flow abstracts data exchange across multiple packets and correspond to traffic patterns. Network flows are commonly used in monitoring and analytics to assess bandwidth usage, detect anomalies, or optimize routing without needing to track individual connections.

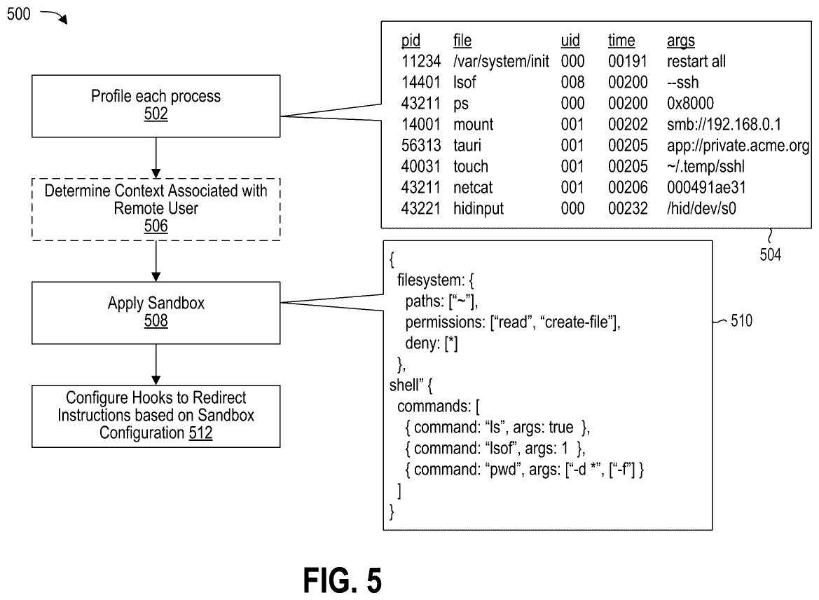

FIG. 5 is a flow diagram 500 illustrating an agent configuring a sandbox for a process in accordance with some aspects of the disclosure.

In some aspects, the flow diagram 500 begins with the agent (e.g., the agent 406 in FIG. 4) profiling each process of the device (e.g., the client device 402 in FIG. 4). For example, the agent may periodically monitor the processes or inject a hook into the OS to invoke a function any time a process is invoked or terminated. In this way, the agent can build a profile over time that considers the system as it changes over time. The agent is configured to receive various contextual information such as a process identifier (pid) of the file being executed (file), a user identifier that triggered the process (e.g., which can be a pid, a user identifier, etc.), and arguments. In some cases, the agent can also detect the timestamp if available or can record a timestamp when the process was first detected.

The agent can use the various information from the processes and build a profile of events and inputs associated with the different processes at block 502. For example, a primary process can trigger tertiary processes, and the profile of the primary process can include how the tertiary processes are triggered, when human input device input is detected, and so forth. In this way, the agent can associate file system events, shell events, and network events with a profile and determine when human input events are driving the primary process and when internal events are driving the primary process. As an example, a list including processes 504 is illustrated and shows process identifiers, executed file (e.g., executable), timestamps, arguments, and so forth that can serve as the basis of the profile for each process.

At block 506, the agent may detect that the human input events are triggered by a remote profile. For example, the agent may detect that the human input events are being driven based on human inputs at a remote device using a virtual network connection to the client device. In this case, the agent may sandbox the client device as further described below. In this case, block 506 is optional because the sandbox can be applied in various contexts.

At block 508, the agent may determine to apply a sandbox on the client device. For example, the agent may restrict permissions for the remote user. In this case, the agent may implement limits into system components based on a sandbox configuration 510. As shown in FIG. 5, the sandbox configuration 510 allows only access to the user home directory (e.g., “~”) and denies other access, and may allow the remote user to read files and create files. However, the user may not be able to remove files. For example, the agent can implement a hook with the filesystem kernel drivers regarding a delete operation, which would intercept the instruction and drop the command. The sandbox configuration 510 may also limit shell access to various commands. For example, the shell access my default defer to deny operations unless explicitly listed in the sandbox configuration 510, which includes the ls, lsof, and pwd shell commands. In some aspects, the shell access can also be used to restrict or permit different arguments. For example, ls includes all arguments, lsof is limited to a single option, and pwd allows arguments of-d with any additional arguments and -f without any additional arguments.

At block 512, the agent uses the sandbox configuration 510 and configures hooks for the eBPF filter to redirect instructions based on the sandbox configuration. In this respect, the agent can provide an additional extra layer of security precautions based on additional context information of the user, such as the remote user. In other cases, the sandbox can be applied in varying contexts, such as based on execution of a particular application.

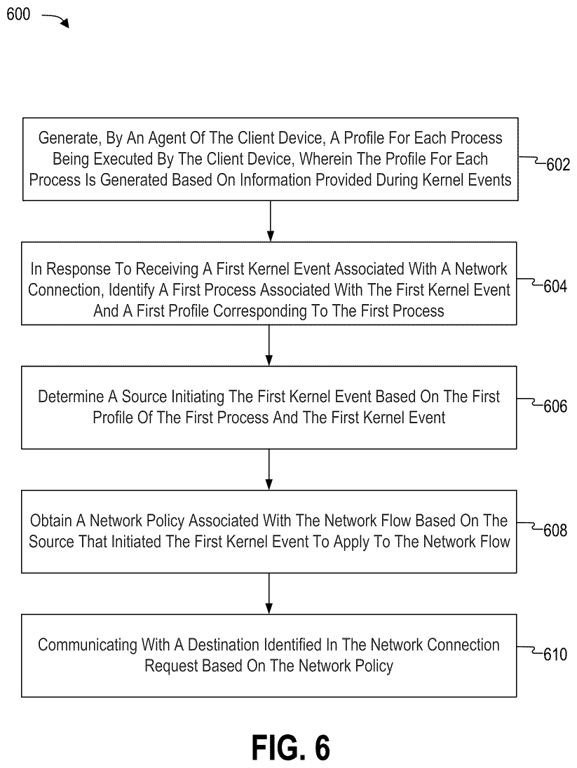

FIG. 6 is a flow diagram of an example process 600 for linking network policy of a client device based on machine or human control in accordance with some aspects of the disclosure. In some aspects, the computing system may implement the process 600 in conjunction with an agent. Although the agent is described as executing the process 600 below, the agent is executing in conjunction with various components of a computing system.

At block 602, the agent (executing via the computing system) may generate a profile for each process being executed by the client device. In some aspects, the profile for each process is generated based on information provided during kernel events. For example, the kernel events (e.g., file system events, process events, etc. in the kernel space) can be mapped to the process and corresponding data (e.g., arguments, etc.) can be stored in the process profile to assess control information of the process (e.g., whether the process is performing a human-initiated action or a machine-initiated action). For example, the agent may record metadata associated with the network flow and update the first profile corresponding to the first process based on the metadata. As an example, the metadata may include at least one of process information of processes (e.g., the processes 504 in FIG. 5) initiated by the first process, and network metadata associated with the network flow (e.g., average latency, transmission size, jitter, etc.) and data transmitted via the network flow.

In some aspects, the first kernel event is a socket event associated with a transmission control protocol connection or a universal data protocol connection. In some aspects, the agent may include an eBPF functionality to register hooks that are invoked on a kernel interface, such as connect( ), accept( ), or bind( ) applied to a network interface. An example of a hook, which can be considered a middleware that is executed based on any call to the kernel interface, is illustrated below.

```
TABLE 1
struct SockAddr {
  sa_family: u16,
  sa_data: [u8; 14],
}
#[tracepoint(name = ″ connect″)]
pub fn connect_hook(ctx: TracePointContext) -> u32 {
  match try_connect_hook(ctx) {
    Ok(ret) => ret,
    Err(_) => 1, // Return non-zero to signal an error
  }
}
fn try_connect_hook(ctx: TracePointContext) -> Result<u32, u32> {
  // Extract syscall arguments
  let args: [u64; 5] = unsafe { mem::transmute(ctx.args( )) };
  let sockaddr_ptr = args[1] as *const SockAddr;
  if sockaddr_ptr.is_null() {
    return Ok(0);
  }
  let sockaddr = unsafe { *sockaddr_ptr };
  // Extract port if IPv4
  if sockaddr.sa_family == libc::AF_INET as u16 {
    let port = u16::from_be_bytes([sockaddr.sa_data[0], sockaddr.sa_data[1]]);
    info!(&ctx, ″connect( ) called: port={ }″, port);
  } else {
    info!(&ctx, ″connect( ) called: non-IPv4 address″);
  }
  Ok(0)
}
  //in the main loop:
  let program: &mut TracePoint = bpf.program_mut(″connect″).unwrap( ).try_into( )?;
  program.load( ) ?;
  program.attach(″syscalls″, ″connect″)?;
```

In Table 1, the public function connect_hook is added in the main program loop to connect the try_connect_hook into the execution pipeline of the connect( ) function, allowing it to be executed anytime connect( ) is called.

At block 604, the agent (executing via the computing system) may, in response to receiving a first kernel event associated with a network connection to a destination address, identify a first process associated with the first kernel event and a first profile corresponding to the first process. In this example, the first kernel event is associated with a network flow of data to the destination address. For example, the first kernel event may be associated with initiating a transmission of content, such as a OS triggered update event or a user triggered event.

At block 606, the agent (executing via the computing system) may determine a source initiating the first kernel event based on the first profile of the first process and the first kernel event. In one aspect, the source initiating the first kernel event comprises one of a user, the first process, and a second process that executes the first process. For example, the kernel event can be tied to a human input device event or closely correlated in time to the event (e.g., within microseconds). In one aspect, to determine the source initiating the first kernel event, the agent may identify a collection of kernel events (e.g. zero or more) proximate to a time of the first kernel event, identify a collection of user input events (e.g., zero or more) proximate to the time of the first kernel event, and determine the source based on comparing the collection of kernel events, the collection of user input events, and the first profile of the first process.

The agent may check events proximate to a time of the inputs associated with the process. For example, when a network request is provided, the agent analyzes other events proximate to the process such as identifying user input events proximate to the time of the network connection request. The absence of input events, for example, can indicate the presence of machine control. In some cases, the agent may be based on identifying a user input or a process corresponding to an event that triggers the network connection request, determining the source of the network connection request. The agent looks at a large number of factors, such as user identifiers, process identifiers, arguments, etc., to ascertain the source of the network request. All of this information is mapped into the profile of each process.

The comparison of the kernel events, the user input events, and the profile can occur a number of different ways, such as weighting of events based on time before the first kernel event, cross referencing available information, identifying patterns in the profile. As an example, a reducer, which is a function to filter and reduce data from one form into a different representation, can be implemented to identify pertinent data, generate a score based on cross-referencing data with the profile, and identify a probability of the kernel event being triggered by a user event. A reducer is just one example, there any various techniques that can be employed to analyze the data.

At block 608, the agent (executing via the computing system) may obtain a network policy associated with the network flow based on the source that initiated the first kernel event to apply to the network flow. For example, the agent may connect to a network infrastructure node that provides network policies per network connection or network policies per network flow.

At block 610, the agent (executing via the computing system) may communicate with the destination address using the network connection based on the network policy applied to the network flow. In some cases, the network connection can already be established, such as a persistent connection to object storage of an internal network. When a large transaction (e.g., upload) is requested with the object storage by a user, because the connection is requested by the user, the network policy can be configured to prioritize this transaction.

In some aspects, when the source that initiated the first kernel event corresponds to the user, the agent may also determine if the user is accessing the client device using a remote connection. If the user is accessing the client device, the agent may intercept file system events and shell events initiated by the user and applying a policy to the file system events and the shell events. For example, the agent may apply a hook (e.g., pipeline processing function) to a kernel interface (e.g., as shown above) to intercept and control a process event based on permitted controls specified in the network policy. A process event is an instruction to control a process lifecycle, such as spawn a process, kill a process, pause a process, and so forth. The kernel event can include signal triggered events (e.g., SIGKILL, SIGINT, SIGCHILD), input/output redirection via stderr or stdout, pipe communication, system call events such as fork( ) and child( ), timers, exception events, shell-specific events, etc. In another example, the agent may apply a hook to a kernel interface to intercept a file system event and redirect the file system event. For example, in response to a request to read a file, the hook can provide an empty file in response. In this manner, if the user is accessing via a remote interface, the agent can implement a sandbox and may limit access to the system.

In some aspects, the agent may detect a reclassification event associated with a process. For example, the agent may detect a significant amount of human input device provided to the process, which is at least partially indicative of human input events. Based on the reclassification event, the agent detecting a reclassification event based on a second kernel event associated with the first process and then determine a source initiating the second kernel event based on the first profile of the first process. For example, the agent may request the network policy from an infrastructure node based on the reclassified source. In this manner, the agent is capable of dynamic switching based on a profiling the processes, mapping inputs, and stateful observation of the processes.

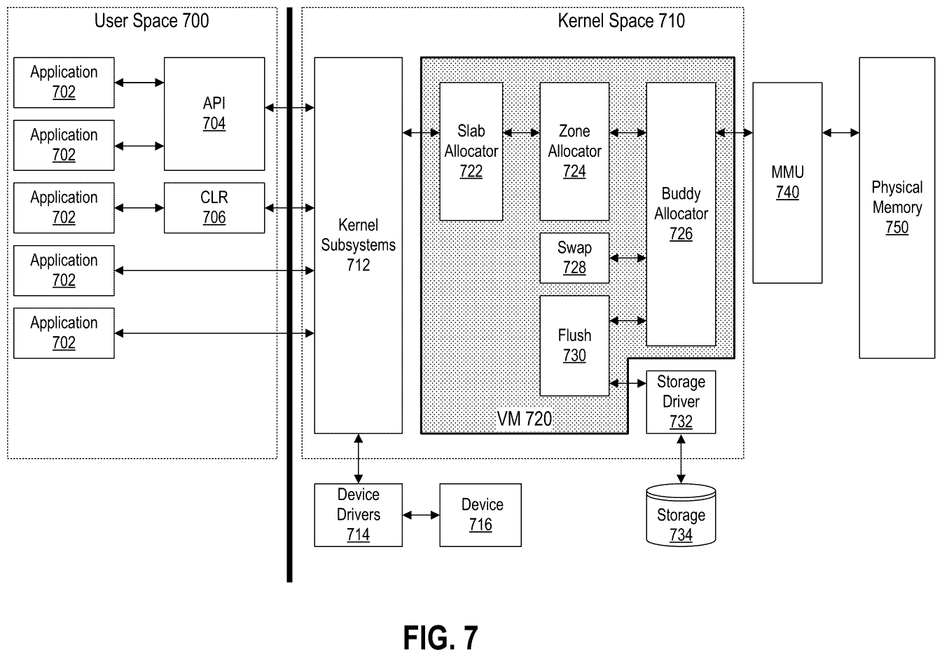

FIG. 7 illustrates a logical diagram of memory space of an operating system (OS) in accordance with an embodiment. In particular, FIG. 7 illustrates that a user space 700 and a kernel space 710 are separated by a logical barrier to isolate application and system resources for security purposes and system purposes. Specifically, FIG. 7 illustrates data from the user space 700 and a kernel space 710 are mapped into the physical memory 750. The physical memory can be implemented by any suitable random access memory (RAM) such as static RAM (SRAM) or synchronous dynamic RAM (SDRAM).

A modern operating system can implement a virtual memory that collects and manages memory from a collection of memory devices (e.g., non-volatile hard disk or other non-volatile storage media to provide additional program memory) to create a virtual memory, a protected memory, and a shared memory. A virtual memory is a collection of all memories, a protected memory provides exclusive access to a region of memory that is allocated to a process, and a shared memory provides cooperative access to a region that is shared by multiple processes.

Memory is configured in distinct units and can vary based on the type of memory. For example, a hard disc allocates blocks in 512 bytes intervals and a Linux kernel allocates a page of memory in 4096 byte intervals.

In the example illustrated in FIG. 7, a plurality of applications such as application 702 that execute within the user space 700 and may call an application programming interface (API) such as API 704 or may use a common language runtime (CLR) such as CLR 706 (e.g., java, C #, webassembly) to access the kernel subsystems 712 in the kernel space. The API 704 of the CLR 706 can implement logic to manage the heap, which is a dynamically sized memory that changes during runtime (e.g., as the application executes).

For example, an application 702 written in C #may use the CLR 706 to perform a network request to another device. The application 702 itself includes instructions that are executed by the CLR 706 or API 704 to interact with the kernel subsystems 712. In this case, the API 704 or the CLR 706 manages the heap of the application.

The kernel subsystems 712 also provide access to hardware devices. For example, the application 702 includes instructions for the CLR 706 to execute a network request. In this case, the CLR 706 generates and provides the request to the kernel subsystems 712, which provides suitable instructions to a device driver 714 to perform the network request using the device 716. For example, the device 716 could be a network interface to execute an HTTP get request for specific data (e.g., a request to retrieve a web page).

In some cases, an application 702 may implement its own heap management functions and directly interact with the kernel subsystems 712 without the API 704 or the CLR 706. Although not illustrated, such an application 702 may operate with an API 704 on a selective basis to perform some functions (e.g., interaction with devices 716) but omit other aspects (e.g., heap management).

The kernel subsystems 712 uses a virtual machine (VM) such as VM 720 to handle management of the physical memory 750 and perform access (e.g., read/write) functions. The VM 720 comprises a slab allocator 722, a zone allocator 724, and a buddy allocator 726 for controlling memory allocation and access.

The buddy allocator 726 allocates physically contiguous blocks of memory within the entire system. Specifically, the buddy allocator 726 allocates pages and maps each page into a memory management unit (MMU) such as MMU 740 that performs the read and write operations in the physical memory 750. The buddy allocator 726 receives a memory request and maps the request to a valid physical address range for the MMU 740. The buddy allocator 726 receives a request for a memory allocation and thereby allocates pages of memory. The buddy allocator 726 prefers to allocate contiguous portions of memory for applications. In some hardware configurations, the MMU 740 may not be present and may be implemented by a software module.

The zone allocator 724 is used to allocate pages in different zones that are designed by the OS. For example, zones can include a direct memory access (DMA) zone, a normal zone, and a high memory zone. The DMA zone is provided for direct memory operations of legacy devices. The normal zone includes memory addresses used by the kernel for internal data structures as well as other system and user space allocations. The high memory zone is used for allocation of system resources (e.g., file system buffers, user space allocations, etc.).

The slab allocator 722 can provide finer control by creating pages and segmenting the pages into caches that are initialized by the zone allocator 724. In some examples, the slab allocator 722 creates different caches for each object type (e.g., inode_cache, dentry_cache, buffer_head, vm_area_struct) for storing each object in the corresponding cache.

The VM 720 may also include a swap 728 and a flush 730 that are used for maintaining the swap, which is conventionally used to handle memory addressing when the physical memory 750 becomes largely or fully utilized. The flush 730 may interact with a storage driver 732, which stores swap content in a non-volatile storage 734.

The kernel space 710 is controlled and only accessible to the kernel because it provides all mechanisms to access the physical memory 750 and the non-volatile storage 734. The various applications such as application 702 store data within the user space 700. The user space 700 and kernel space 710 are separated to isolate separate concerns and provide a security barrier to prevent applications from intentionally or unintentionally writing in the kernel space 710. For example, in the example of the network request, the C #application is not concerned about the implementation details of the network request (e.g., a WebSockets request) and is concerned about whether the request is successful or not. Therefore, the user space 700 contains the application information for the network request and the kernel space 710 stores information required to implement that network request.

The kernel space 710 implements security precautions and attempts to prevent access by applications to prevent intentional and unintentional malicious memory access from occurring. For example, the kernel space 710 may attempt to prevent a row hammer attack, which is a repeated bit-flipping of a row of memory addresses to attempt to cause neighboring bits to unintentionally flip values due to electromagnetic effects of repeated bit flipping. Row hammer attacks can be used to escalate user privileges so that a malicious entity can access the kernel space 710.

The VM 720 is an example of a memory management system that manages the physical memory and separates application content in the user space 700 and system content in the kernel space 710. Another OS may implement a memory management subsystem differently but use similar concepts to provide a layer of system security to prevent applications such as application 702 from being able to access the kernel space 710.

In some instances, the processor and/or the system itself may include additional devices to provide additional layers of security. For example, the processor, which is not illustrated in FIG. 7, may include a secure register that is not available for general use and has security precautions. For example, a processor may include a secure configuration register (SCR) that can be programmed during a boot sequence with a security score. A specific hardware component may be configured to calculate the security score during the boot sequence and store that score in the SCR.

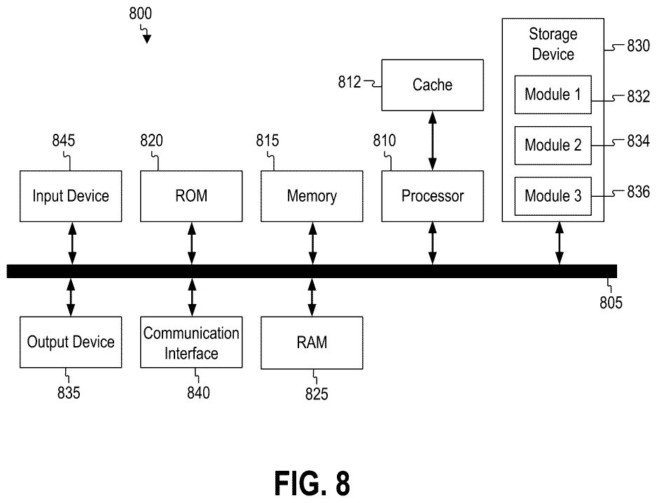

FIG. 8 shows an example of computing system 800, which can be for example any computing device making up the client device 110, the system 200, the client device 302, the client device 402 and other devices described herein, or any component thereof in which the components of the system are in communication with each other using connection 805. Connection 805 can be a physical connection via a bus, or a direct connection to processor 810, such as in a chipset architecture. Connection 805 can also be a virtual connection, networked connection, or logical connection.

In some embodiments, the computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In one example, computing system 800 includes at least one processing unit (CPU or processor) such as processor 810 and connection 805 that couples various system components including system memory 815, read-only memory (ROM) such as ROM 820 and random access memory (RAM) such as RAM 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service may be software that resides in memory of a client device and/or one or more servers of a content management system and perform one or more functions when a processor executes the software associated with the service. In some embodiments, a service is a program, or a collection of programs that carry out a specific function. In some embodiments, a service may be considered a server. The memory may be a non-transitory computer-readable medium.

In some embodiments the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Methods according to the above-described examples may be implemented using computer-executable instructions that are stored or otherwise available from computer readable media. Such instructions may comprise, for example, instructions and data which cause or otherwise configure a general-purpose computer, special purpose computer, or special purpose processing device to perform a certain function or group of functions. Portions of computer resources used may be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures may comprise hardware, firmware and/or software, and may take any of a variety of form factors. Typical examples of such form factors include servers, laptops, smartphones, small form factor personal computers, personal digital assistants, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality may be distributed differently or performed in components other than those identified herein. Rather, the described features and steps are disclosed as examples of components of systems and methods within the scope of the appended claims.

What is claimed is:

1. A method for setting network policies at a client device, the method comprising:
generating, by an agent of the client device, a profile for each process being executed by the client device, wherein the profile for each process is generated based on information provided during kernel events;
in response to receiving a first kernel event associated with a network connection to a destination address, identifying a first process associated with the first kernel event and a first profile corresponding to the first process, wherein the first kernel event is associated with a network flow of data to the destination address;
determining a source initiating the first kernel event based on the first profile of the first process and the first kernel event, wherein the source initiating the first kernel event comprises one of a user, the first process, and a second process that executes the first process;
obtaining a network policy associated with the network flow based on the source that initiated the first kernel event to apply to the network flow; and
communicating with the destination address using the network connection based on the network policy applied to the network flow.

2. The method of claim 1, wherein the first kernel event is a socket event associated with a transmission control protocol connection or a universal data protocol connection.

3. The method of claim 1, further comprising:
when the source that initiated the first kernel event corresponds to the user, determining if the user is accessing the client device using a remote connection.

4. The method of claim 3, further comprising:
intercepting file system events and shell events initiated by the user based on the user accessing the client device using the remote connection; and
applying a policy to the file system events and the shell events.

5. The method of claim 4, wherein applying the policy to the shell events comprises:
applying a hook to a kernel interface to intercept and control a process event based on permitted controls specified in the network policy.

6. The method of claim 4, wherein applying the policy to the file system events comprises:
applying a hook to a kernel interface to intercept a file system event and redirect the file system event to an empty file.

7. The method of claim 1, wherein determining the source initiating the first kernel event comprises:
identifying a collection of kernel events proximate to a time of the first kernel event;
identifying a collection of user input events proximate to the time of the first kernel event; and
determining the source based on comparing the collection of kernel events, the collection of user input events, and the first profile of the first process.

8. The method of claim 1, further comprising:
detecting a reclassification event based on a second kernel event associated with the first process, wherein the second kernel event indicates a change to the first process; and
determining a source initiating the second kernel event based on the first profile of the first process.

9. The method of claim 1, further comprising:
recording metadata associated with the network flow; and
updating the first profile corresponding to the first process based on the metadata.

10. The method of claim 9, wherein the metadata includes at least one of process information of processes initiated by the first process, and network metadata associated with the network flow and data transmitted via the network flow.

11. A client device for setting network policies, comprising:
a network device; and
at least one processor coupled to the network device and configured to:
generate a profile for each process being executed by the client device, wherein the profile for each process is generated based on information provided during kernel events;
in response to receiving a first kernel event associated with a network connection to a destination address, identify a first process associated with the first kernel event and a first profile corresponding to the first process, wherein the first kernel event is associated with a network flow of data to the destination address;
determine a source initiating the first kernel event based on the first profile of the first process and the first kernel event, wherein the source initiating the first kernel event comprises one of a user, the first process, and a second process that executes the first process;
obtain a network policy associated with the network flow based on the source that initiated the first kernel event to apply to the network flow; and
communicate with the destination address using the network connection based on the network policy applied to the network flow.

12. The client device of claim 11, wherein the first kernel event is a socket event associated with a transmission control protocol connection or a universal data protocol connection.

13. The client device of claim 11, wherein the at least one processor is configured to:
when the source that initiated the first kernel event corresponds to the user, determine if the user is accessing the client device using a remote connection.

14. The client device of claim 13, wherein the at least one processor is configured to:
intercept file system events and shell events initiated by the user based on the user accessing the client device using the remote connection; and
apply a policy to the file system events and the shell events.

15. The client device of claim 14, wherein the at least one processor is configured to:
apply a hook to a kernel interface to intercept and control a process event based on permitted controls specified in the network policy.

16. The client device of claim 14, wherein the at least one processor is configured to:
apply a hook to a kernel interface to intercept a file system event and redirect the file system event to an empty file.

17. The client device of claim 11, wherein the at least one processor is configured to:
identify a collection of kernel events proximate to a time of the first kernel event;
identify a collection of user input events proximate to the time of the first kernel event; and
determine the source based on comparing the collection of kernel events, the collection of user input events, and the first profile of the first process.

18. The client device of claim 11, wherein the at least one processor is configured to:
detect a reclassification event based on a second kernel event associated with the first process, wherein the second kernel event indicates a change to the first process; and
determine a source initiating the second kernel event based on the first profile of the first process.

19. The client device of claim 11, wherein the at least one processor is configured to:
record metadata associated with the network flow; and
update the first profile corresponding to the first process based on the metadata.

20. The client device of claim 19, wherein the metadata includes at least one of process information of processes initiated by the first process, and network metadata associated with the network flow and data transmitted via the network flow.
